(19) United States
(12) Patent Application Publication
(10) Pub. No.: US 2005/0059414 A1
(43) Pub. Date: Mar. 17, 2005

(54) System and method of communicating a plurality of food orders in a restaurant

(76) Inventors: Abolghassem B. Mahmoodi, Saint Paul, MN (US); Steven T. Awiszus, Woodbury, MN (US)

Correspondence Address: 3M INNOVATIVE PROPERTIES COMPANY, PO BOX 33427, ST. PAUL, MN, 55133-3427, US

(21) Appl. No.: 10/661,714

(22) Filed: Sep. 12, 2003

(51) Int. Cl. H04Q 7/20

(52) U.S. Cl. 455/456.2

(57) ABSTRACT

System and method of communicating a plurality of food orders in a restaurant from a plurality of portable ordering devices to a food preparation area. Handwritten indicia representative at least an aspect of one of the plurality of food orders is created on one of the plurality of ordering devices. The indicia is communicated wirelessly from the one of the plurality of portable ordering devices for display in the food preparation area. Completion of the one of the plurality of orders can, optionally, be wirelessly communicated to the one of the plurality of portable ordering devices.

### TECHNICAL FIELD

This invention relates to systems and methods of communicating a plurality of food orders in a restaurant and, more particularly, to such systems and methods involving wireless communication utilizing portable ordering devices.

### BACKGROUND

Establishments in the food and beverage industry can be very busy places, especially during peak business hours. During any part of the business day, but especially during peak times, wait staff personnel can sometimes be challenged to keep up with demands from customers. Duties of the wait staff can include greeting customers, explaining menu options, taking an order, communicating the order to the preparation area, possibly delivering the order to the customer, continuing to service the customer's needs and, possibly, facilitating payment from the customer. Wait staff can often be without enough time to effectively serve the customers, possibly resulting in unsatisfied customers who do not return for future service. This can be especially true in times when an establishment is short staffed due to all-too-common personnel issues, such as illness or vacationing personnel. Anything that an establishment can do to alleviate time pressure on wait staff personnel can improve customer satisfaction. Further, improved efficiency in wait staff performance can decrease the number of wait staff required.

A typical wait staff person must, typically orally, take the customer's order and then communicate the order to other personnel who prepare the order to the customer's specifications. It is common for a wait person to handwrite the customer's order on a paper contained in a pad and then hand deliver the handwritten paper to the food and/or beverage preparation area. This is often done by slipping the handwritten paper order onto a rotatable lazy-Susan type device so that the preparation staff can have access to the orders dropped off by the wait staff. During the time that the wait staff are delivering the paper orders to the preparation area, they are, of course, not available to attend to the needs of the customer ordering or other customers. The wait staff often need to keep watch to determine when their customer's orders are complete. This also may detract from the ability of the wait staff to effectively serve their customers.

It is common in establishments such as restaurants for customers to be located in an area separate from the food or beverage preparation area. Wait staff required to physically transport the order from the customer, or serving, area to the preparation area, and possibly to determine when the order is ready, may spend an appreciable portion of their time simply walking between the two areas.

PCT Patent Application No. WO 03/054815 A1, Germinara et al, Tango Softaware House Ltda., entitled “Order Automation System Improvement,” describes an order automation system for use in restaurants which offers special attention to operating the table saloon or waiting lines, by taking orders on electronic forms, based on portable computers type Pocket PC, with LCD colored screen type touch screen and radio frequency wireless communication. The wireless communication eliminates the going and coming of the waiters to and from the kitchen and pantry to deliver and get the orders. The system in Germinara et al uses portable computers, used by attendants, to simulate electronic order forms, specially prepared and previously programmed, making it possible to choose items among those displayed on their screens.

However, requiring wait staff to select from among preprinted forms or previously programmed items, such as selecting one of a plurality of icons, is an inefficient form of order entry. The wait staff typically needs to search to locate the appropriate previously programmed item or icon before the item or icon can be selected. The necessarily small screen of a portable computer limits the number of items or icons which may reasonably be presented on a single screen and, hence, often requires the wait staff to search through multiple screens in order to find the item or icon desired. Further, the previously programmed items or icons either do not allow the wait staff to indicate specific customer preferences, such as adding, withholding or substituting specific ingredients, or causes the number of items or icons to greatly proliferate limiting the effective use of the devices.

### SUMMARY OF THE INVENTION

Wait staff are typically already accustomed to handwriting orders. Either they have previously handwritten orders on paper or are experienced in taking notes from other endeavors and have little trouble recording an order from a customer by creating handwritten indicia. A portable ordering device accepting handwritten indicia from the wait staff can wirelessly communicate the handwritten order to the preparation area, preferably in essentially real time. The order, as written by the wait staff person, can be displayed in the preparation area, often in essentially real time as the order is being written by the wait staff. The preparation staff, such as a cook, chef or bartender, may view the orders exactly as the wait staff has written them. Any special customer preferences can be easily indicated along with order and can be easily recognized by the preparation staff. The wait staff need not wade through a myriad of previously programmed items or icons to find the particular item ordered by the customer. The wait staff eliminates the walking back and forth between the serving area and the preparation area. The order can be communicated to the preparation area earlier than if the wait staff person had walked to the preparation area.

A plurality of orders can be displayed in the preparation area and orders from a plurality of wait staff personnel can be displayed simultaneously. The orders can be identified as having come from a particular wait staff person.

In one embodiment, the present invention provides a method of communicating a plurality of food orders in a restaurant from a plurality of portable ordering devices to a food preparation area. Handwritten indicia representative at least an aspect of one of the plurality of food orders is created on one of the plurality of ordering devices. The indicia is communicated wirelessly from the one of the plurality of portable ordering devices for display in the food preparation area.

In another embodiment, the present invention provides a method of communicating a plurality of food orders in a restaurant from a portable ordering device to a food preparation area. Handwritten indicia representative of at least an aspect of at least an aspect of one of the plurality of food orders is created on a portable ordering device. The indicia is communicated from the portable ordering device for display in the food preparation area.

Further, instead of requiring wait staff personnel from watching for completion of one of their orders, either by returning to the preparation area to check or by another signaling system such as a centralized light system, preparation staff may communicate directly back to the wait staff person submitting an order that the order has been completed. Thus, the wait staff person can immediately know that the order is ready without taking the time to periodically check for the possible completion of the orders. The preparation staff may also communicate other conditions of the order requiring the wait staff's assistance such as a question involved with the order.

In another embodiment, the present invention provides a method of communicating a plurality of food orders in a restaurant from a plurality of portable ordering devices to a centralized food preparation area. One of the plurality of food orders is indicated on one of the plurality of food ordering devices. The indication is wirelessly communicated from the one of the plurality of portable ordering devices in substantially real time for display in the food preparation area, the indicia being uniquely identified with the one of the plurality of portable ordering devices. Completion of the one of the plurality of is wirelessly communicated to the one of the plurality of portable ordering devices.

In another embodiment, the present invention provides a method of communicating a plurality of food orders in a restaurant from a portable ordering device to a food preparation area. One of the plurality of food orders is indicated on the portable ordering device. Indication of the one of the plurality of food order is wirelessly communicated for display in the food preparation area. Completion of the one of the plurality of food orders is wirelessly communicated to the portable ordering device.

In another embodiment, the present invention provides a method of communicating a plurality of food orders in a restaurant from a plurality of portable ordering devices to a food preparation area. Indicia representative of at least one aspect of one of the plurality of food orders is created on one of the plurality of portable ordering devices. The indicia is wirelessly communicated from the one of the plurality of portable ordering devices to the food preparation area, the indicia being uniquely identified with the one of the plurality of portable ordering devices. Completion of the one of the plurality of orders is wirelessly communicated to the one of the plurality of portable ordering devices.

In another embodiment, the present invention provides a method of communicating a plurality of food orders in a restaurant from a portable ordering device to a food preparation area. Indicia representative of at least an aspect of one of the plurality of food orders is created on the portable ordering device. The indicia is wirelessly communicated from the portable ordering device to the food preparation area. Completion of the one of the plurality of orders to the portable ordering device.

In a preferred embodiment, the indicia communicated to the food preparation area is displayed in the food preparation area.

In another embodiment, the present invention provides a system for communicating a plurality of food orders in a restaurant. A plurality of portable ordering devices are capable of wireless communication and are capable of receiving handwritten indicia indicative of one of the plurality of food orders. A communication processor is wirelessly coupled with the plurality of portable ordering devices. A display is operatively coupled to the communication processor. The communication processor wirelessly receives the handwritten indicia uniquely identified with the one of the plurality of portable ordering devices and displays the handwritten indicia on the display.

In another embodiment, the present invention provides a system for communicating a plurality of food orders in a restaurant. A portable ordering device is capable of wireless communication and is capable of receiving handwritten indicia indicative of one of the plurality of food orders. A communication processor is wirelessly coupled with the portable ordering device. A display is operatively coupled to the communication processor. The communication processor wirelessly receives the handwritten indicia and displays the handwritten indicia on the display.

In a preferred embodiment, the communication processor further wirelessly indicates completion of the one of the plurality of food orders to the portable ordering device.

In another embodiment, the present invention provides a system for communicating a plurality of food orders in a restaurant from a plurality of portable ordering devices to a food preparation area. A plurality of portable ordering devices are each capable of wireless communication and of receiving indicia indicative of one of the plurality of food orders. A communication processor is wirelessly coupled with the plurality of portable ordering devices. A display is operatively coupled to the communication processor. The communication processor wirelessly receives the indicia uniquely identified with the one of the plurality of portable ordering devices and displays the indicia on the display. The communication processor wirelessly indicates completion of the one of the plurality of food orders to the one of the plurality of ordering devices.

In another embodiment, the present invention provides a system for communicating a plurality of food orders in a restaurant. A portable ordering device is capable of wireless communication and is capable of receiving indicia indicative of one of the plurality of food orders. A communication processor is wirelessly coupled with the plurality of portable ordering devices. A display is operatively coupled to the communication processor. The communication processor wirelessly receives the indicia and displays the indicia on the display. The communication processor wirelessly indicates completion of the one of the plurality of food orders to the portable ordering device.

In a preferred embodiment, the wirelessly receiving is accomplished in substantially real time.

In a preferred embodiment, the food preparation area is centralized.

In a preferred embodiment, the indicia includes handwritten indicia.

### BRIEF DESCRIPTION OF THE DRAWING

FIG. 1 is a schematic diagram of a food ordering system in accordance with embodiments of the present invention;

FIG. 2 is a screen of a portable ordering device showing order entry;

FIG. 3 is an illustration of an alternative portable ordering device showing order entry;

FIG. 4 is a screen of a display;

FIG. 5 is an illustration of an alternative display;

FIG. 6 is an illustration of a portable ordering showing order completion;

FIG. 7 is a block diagram illustrating the process of an embodiment of the present invention;

FIG. 8 is a flow chart of an embodiment of the present invention; and

FIG. 9 is a flow chart of an alternative embodiment of the present invention.

### DETAILED DESCRIPTION

Food and/or beverage ordering in a restaurant or bar environment, for example, is simultaneously simplified and improved. Food and beverage orders can be wirelessly communicated from wait staff personnel, e.g., from orders taken from a customer in a serving area, using portable ordering devices to a preparation area, e.g., a kitchen or bar, and displayed in the preparation area for action by the preparation staff. Wait staff may record the customer's order using handwritten indicia, with which the wait staff is comfortable and requires no or little initial training, and the preparation staff receives the order, preferably in substantially real time, in the handwritten format to which they are also accustomed.

It should be noted that throughout this description that the term “server” refers to computer hardware and/or software and the term “wait staff” refers to an individual or groups of individuals who serve customers.

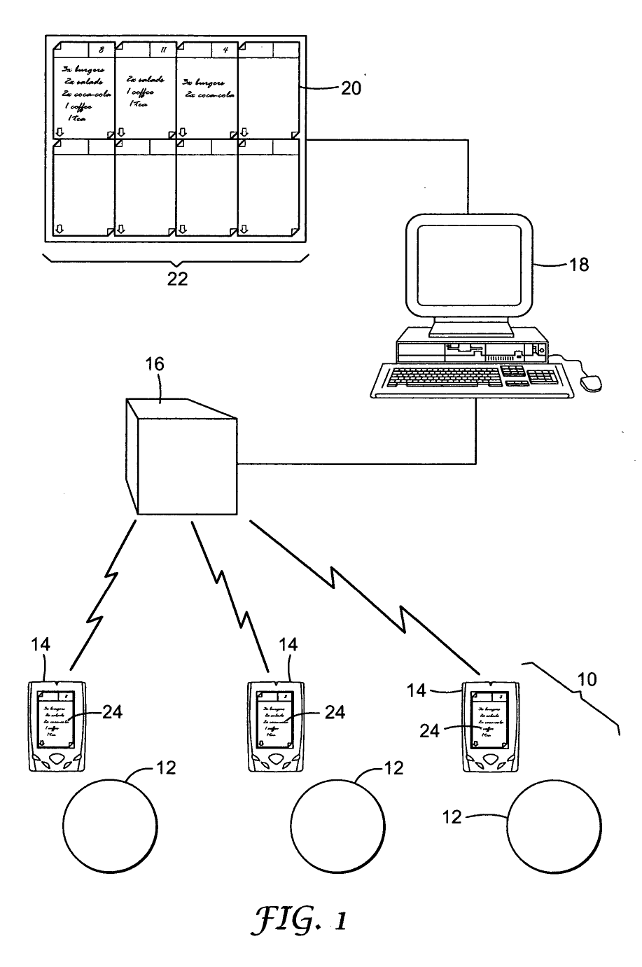

FIG. 1 illustrates in schematic form serving area 10 of a restaurant having a plurality of tables 12. One or more wait staff, such as a waiter, waitress, bartender, bar maid, etc., attends to the gastronomic needs of customers located at tables 12. Each wait person may carry a portable ordering device 14 on which the wait person may create handwritten indicia representative of an order of a customer or customers. Each such order may be wirelessly communicated to wireless access point 16. Wireless access point 16 can then communicate signals representative of the order through server 18, operating as a communication processor, to display 20 visible in food preparation area 22. The order appears on display 20 exactly as it was handwritten by the wait person on portable ordering device 14. As shown in FIG. 1, a plurality of orders may be entered, either sequentially or simultaneously, from a plurality of wait persons in serving area 10 each using a portable ordering device 14. All of the orders can be displayed on display 20 in food preparation area 22.

Since the wait person does not need to hand deliver the order to the preparation area 22, the wait person's job is made more efficient and the wait person can better attend to the customer's needs.

Portable ordering devices 14 can be any of a variety of well known and conventional personal digital assistants such as a Casio BE-300. Preferably, portable ordering devices 14 are selected for their ruggedness and durability.

Wireless communication between portable ordering devices 14 and wireless access point 16 can be accomplished by any of several well known and conventional wireless communication protocols including RF communication, Bluetooth and the various flavors of the protocols under 802.11. In a preferred embodiment, wireless communication operates under the provisions of 802.11b. Access point 16 can be any of a number of well known and conventional access points such as those manufactured by Linksys Corporation.

In a preferred embodiment, server 18 is a general purpose computer with a one (1) gigaHertz Intel™-based processor, 128 megabytes of random access memory and a 40 gigabyte hard drive with Microsoft™ Windows™ XP operating system. Server 18 also includes a monitor, keyboard and pointing device, e.g., a mouse, for administration purposes. Server 18 is operatively coupled with display 20 by way of video cable 21.

Display 20 can be any of a variety of well known and conventional displays selected to be suitable for viewing in food preparation area 22. Display 20 can either be cathode ray tube or flat panel, for example. The size can be adapted to be suitable for the size of food preparation area 22, the number of orders desired to be visible at one time, the number of preparers viewing display 20 and their distance from display 20.

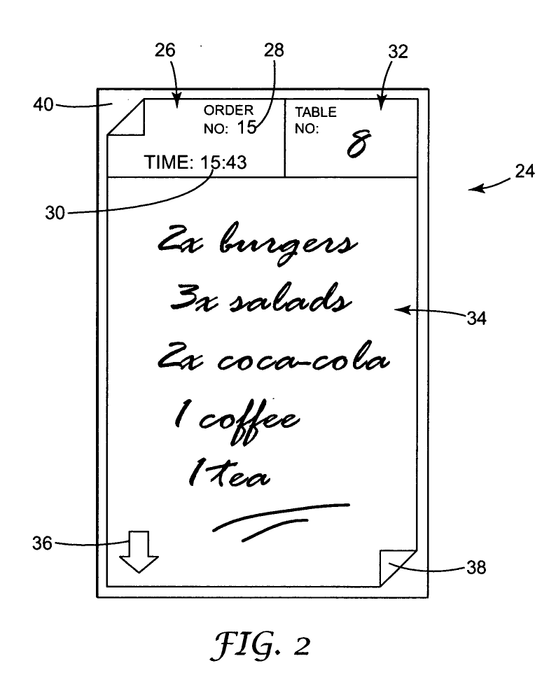

FIG. 2 illustrates a screen shot of portable ordering device 14. Screen 24 is divided into several sections. Section 26 displays the order number 28 on the portable ordering device 14. Order number 28 is sequentially generated by ordering device 14. Each order number is unique with each portable ordering device 14. Time 30 is generated by portable ordering device 14 and is also wirelessly synchronized with server 18.

Section 32 is an area of screen 24 in which the wait person may indicate, preferably by handwritten indicia, the particular spot in serving area 10 the customer is located. Typically, the table number, table number 8 in the example provided in FIG. 2, is the identification provided.

Section 34 is an area of screen 24 in which the wait person may indicate, preferably by handwritten indicia, the order received by the wait person. In this example, the wait person has handwritten two “burgers,” three “salads,” two “Coca-Colas”™ [drinks], one coffee and one tea. It can be seen that creating handwriting indicia representative of the order requires no special training and does not require the wait person to sort through pre-existing icons, or pre-existing menus to even locate icons. The process can be completely easily and promptly allowing the wait person to continue further serving the customers.

Section 34 contains downward arrow 36 which allows the wait person to continue the same order on another screen similar to screen 24. This process can be repeated for a reasonable and predetermined number of additional screens or an unlimited number of screens, as desired. Thus, the wait person is not limited to a single screen, or even to fixed number of screens, in which to fit the order. Whatever screen space is necessary may be used by the wait person. Whatever the wait person writes on screen 24 is displayed on display 20 in preparation area 22.

Note that it is extremely easy for the wait person to indicate customer preferences, substitutions or special orders directly on the screen. If the customer wants ketchup and onions for the burger(s), the wait person can simply note that on the order. If the customer prefers the carbonated beverage(s) without ice; that too can be easily indicated on the order. There is no requirement for the wait person to select a particular menu item or icon to indicate preferences or other order customizations.

When the wait person has completed entering the order on portable ordering device 14, the wait person can touch corner 38 to complete the order and bring up a fresh screen 24 for entry of a new order.

Wait person can also touch corner 40 to return to an earlier order in order to amend the order. Whatever changes are made to an order show up on display 20 in preparation area 22.

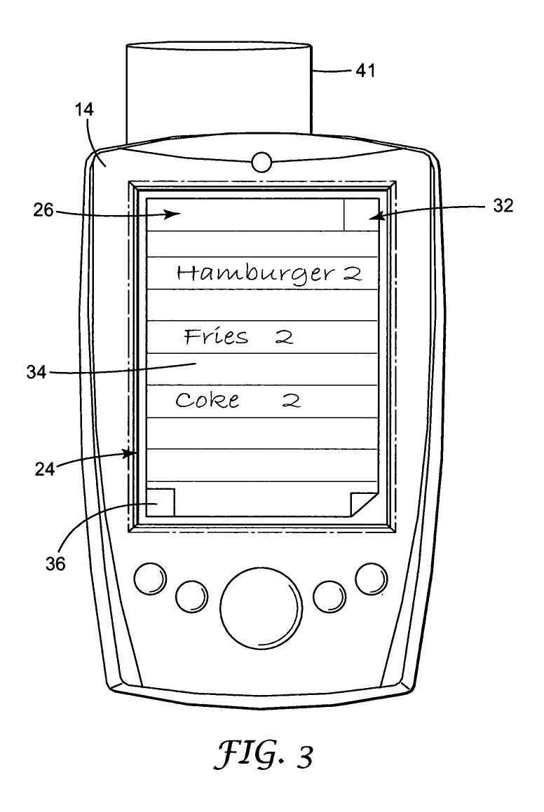

FIG. 3 is an alternative implementation of portable ordering device 14 illustrating another example of an order having been handwritten in section 34 of screen 24. In this implementation, section 26 has been enlarged and section 32 somewhat decreased in size. Down arrow 36 is simply a box indicating an area of screen 24 which may be touched to continue the order on another screen 24. The order illustrated in FIG. 3 includes two “hamburgers,” two “fries” and two “Cokes”™ drinks. Portable ordering device 14 is a Dell™ Axim™ PocketPC. An iWavePort 802.11b wireless card 41 is incorporated in portable ordering device 14 for wireless communication with wireless access point 16.

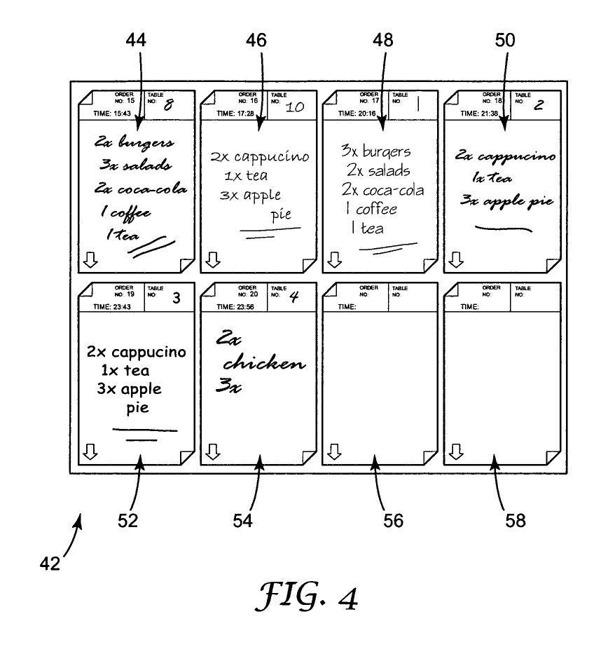

FIG. 4 is a screen shot 42 of display 20. Screen 42 of display 20 is divided into eight (8) sections. Each section of screen 42 represents a screen 24 from one portable ordering device 14. Thus, section 44 of screen 42 is representative of the order handwritten on screen 24 of portable ordering device 14 illustrated in FIG. 2. Note that what appears in section 44 of screen 42 is essentially a reproduction of screen 24 of portable ordering device 14. Thus, whatever the wait person handwrites on screen 24 of portable ordering device 14 is available for viewing on display 20. Since preparation staff are already used to reading wait persons' orders from paper order slips, it is easy for preparation personnel to understand the order submitted.

Sections 46, 48, 50, 52 and 54 represent orders which have been indicated on other portable devices 14 or other orders which have been indicated on the portable ordering device 14 which produced the order represented in section 44. In a preferred embodiment, orders from a plurality of portable ordering devices 14 are displayed on screen 42 of display 20 for viewing in preparation area 22. This allows preparation staff to view orders from multiple devices on one screen 42.

In a preferred embodiment, each order is uniquely identified with a particular one of the plurality of ordering devices 14. That is, the order represented by section 44 of screen 42 is uniquely identified with the particular portable ordering device 14 which produced the order illustrated in FIG. 2. While screen 42 of display 20 may contain information relative to orders from a plurality of portable ordering devices 14, screen 24 on each portable ordering device 14 will only contain information relating to the orders placed by that particular portable ordering device 14.

In a preferred embodiment, indicia of an order created, or being created, on screen 24 of portable ordering device 14 is reproduced in real time, or substantially real time, on screen 42 of display 20. This is illustrated in section 54 of screen 42 where the portable ordering device 14 taking the order for table number four (4) is in process of being handwritten. The order so far includes two “chickens” (which could be indicative of chicken sandwiches, depending upon the restaurant involved) and three of the next item which hasn't yet been completed. Reproducing an order being written on a portable ordering device 14 in substantially real time can be advantageous allowing preparation staff to get a “head start” on an order before it is even completed. As an example, an order may begin with drinks or with an appetizer. These items can be started by preparation staff even before the order is complete potentially allowing the customer to receive these initial items even faster. Substantially real time generally means that the order is displayed substantially without intentional delay or generally as fast as communication and software delays allow. In any event, in substantially real time means that the order is displayed on display 20 before the order is completed on portable ordering device 14.

Note that while screen 42 can display a total of eight (8) orders, including sections of orders, that sections 56 and 58 are blank and do not yet display an order. As an additional order is written on a portable ordering device 14, that additional order will be displayed in section 56 of screen 42.

If more than eight (8) orders are pending, then either display 20 can display all orders using multiples of screen 42 selectable by preparation staff, for example by scroll up and down buttons or touch areas. The number of orders displayable is limited only by the amount of storage allocated for this purpose. In a preferred embodiment, memory is allotted to accommodate up to ninety (90) simultaneous orders. Alternatively, display 20 can simply display only the eight (8) oldest orders written. Of course, any additional orders can be stored in a digital file. From there, the orders can be recalled for display or printed.

The orders come up as they are taken down with the PDA. The maximum file size that appears on a screen is eight; however, additional ones can be added—you can scroll up and down on the screen to see them eight at a time. The number of orders that can be displayed depends on the memory of the system that is allocated to the video display. In the software, we have set aside enough video memory to take up to ninety orders. One can store these orders into a digital file or have them printed and get a hardcopy of them.

As preparation staff complete an order, the preparation staff indicate such completion, such as by mouse clicking or touching a portion of screen 42 of display 20 or by operating a push button or foot pedal, such as a bump bar (commonly used in a “fast food” type of restaurant).

After an order is indicated as being completed, that order will no longer occupy the section of screen 42 associated with that order. All other orders on screen 42 will then move up to occupy the next available section on screen 42. As an example, if preparation staff indicate completion of the order for table eight (8) represented by section 44 (two “burgers,” three “salads,” two “Coca-Colas”™ [drinks], one coffee and one tea), then section 44 would shift to display the order previously occupying section 46 (two “cappuccinos,” one “tea” and three “apple pies”). Similarly, the order for table one (1) in section 48 would move up to section 46; the order for table two (2) in section 50 would move up to section 48; the order for table three (3) in section 52 would move up to section 50, and so on. The result is that section 44 of screen 42 represents the oldest order outstanding and not yet completed.

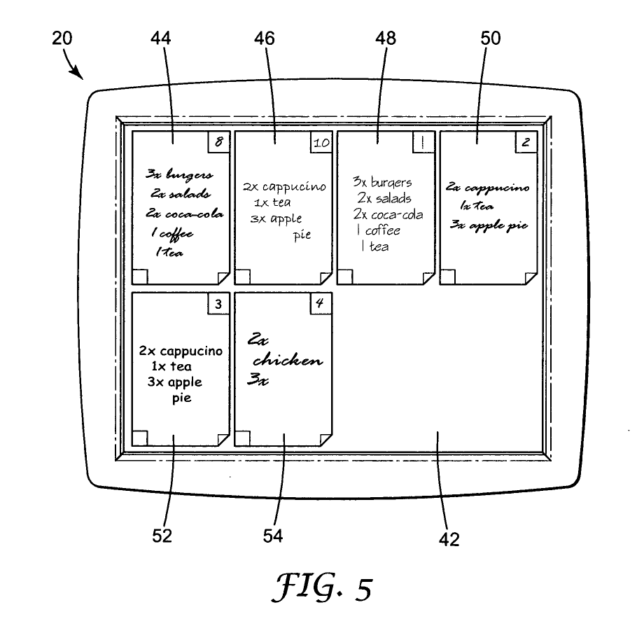

FIG. 5 is an illustration of an alternative embodiment of screen 42 of display 20.

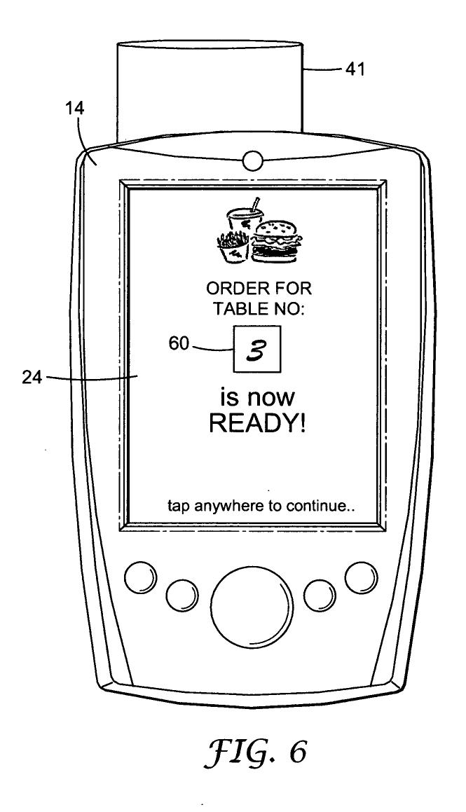

Each order transmitted by a portable ordering device 14 is uniquely identified with the portable ordering device 14 sending the order. Completion of an order by the preparation staff causes an indication to be communicated back to the portable ordering device 14 which originated the order. FIG. 6 is an illustration of a portable ordering device 14 which has received an indication that an order has been completed by the preparation staff. Screen 24 of portable ordering device 14 displays indicia indicating that an order originating with that portable ordering device 14 is now ready. The display on screen 24 also indicates which the table number 60, in this example table number 3, from which the order originated, namely the information contained in section 32 of screen 24 of the portable ordering device when the order was placed.

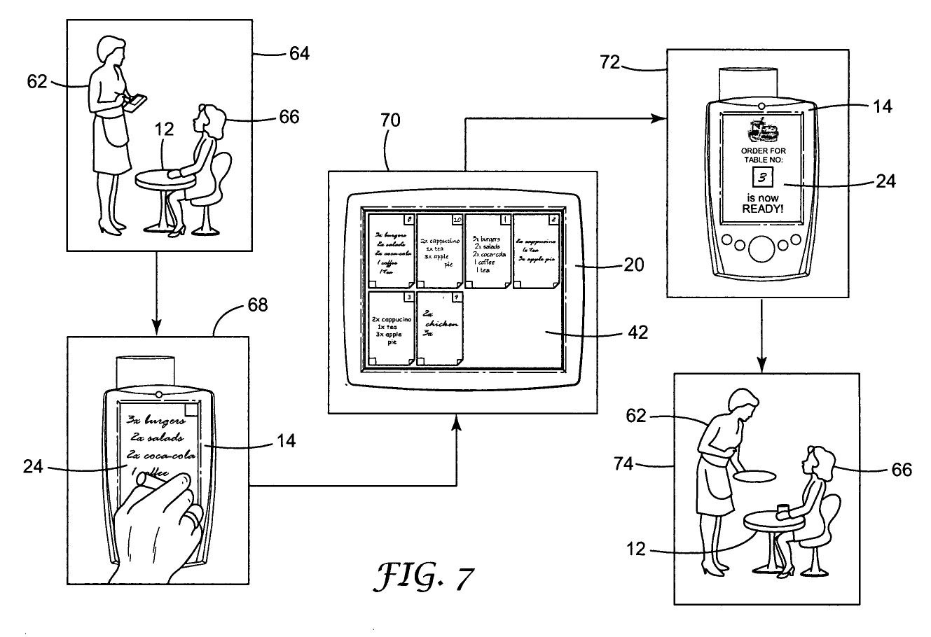

FIG. 7 generally illustrates the flow of the process of communicating food orders in a restaurant. Software performing food order communication tasks is initiated on both server 18 and a portable ordering device 14. Wait staff person 62 takes an order [block 64] from a customer 66 at table 12 and creates handwritten indicia [block 68] representative of the order on portable ordering device 14 including the table number and a description of the items ordered. Screen 42 of display 20 is synchronized [block 70] with screen 24 of portable ordering device 14. A portion of screen 42 displays whatever wait staff person 62 creates on screen 24 of portable ordering device 14. Completion of the order is indicated in preparation area 22 and such completion is indicated [block 72] on screen 24 of portable ordering device 14. The order can then be delivered [block 74], by wait staff person 62 or other personnel, to customer 66 at table 12. Wait staff person 62 or other personnel have the option of printing a hard copy of the order, for example, for use in a bill, or saving the order in a digital file for later recall and possible printing.

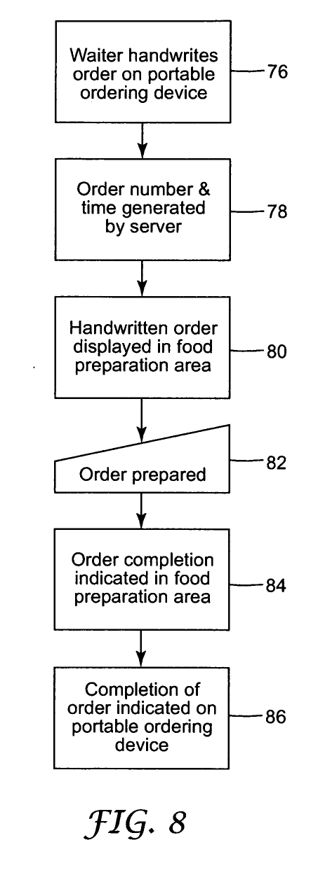

FIG. 8 is a flow chart illustration of an embodiment of the present invention. A wait staff person 62 handwrites (creates handwritten indicia) representative of an order [block 76] on a portable ordering device 14. An order number, unique to that order, is optionally generated [block 78] by server 18. The time of the order is also confirmed at this step. The indicia representative of the handwritten order is displayed [block 80] in the food preparation area 22. The preparation staff prepare the order [block 82] (which is included for clarity but isn't actually a part of the communication process). In an embodiment, order completion is indicated [block 84] in the food preparation area 22. Completion of the order is indicated [block 86] on portable ordering device 14. While order completion steps indicated in blocks 84 and 86 are illustrated as separate steps to illustrate the geographic impact, it is to be recognized and understood that these steps can be considered a single step of communicating order completion to portable ordering device 14.

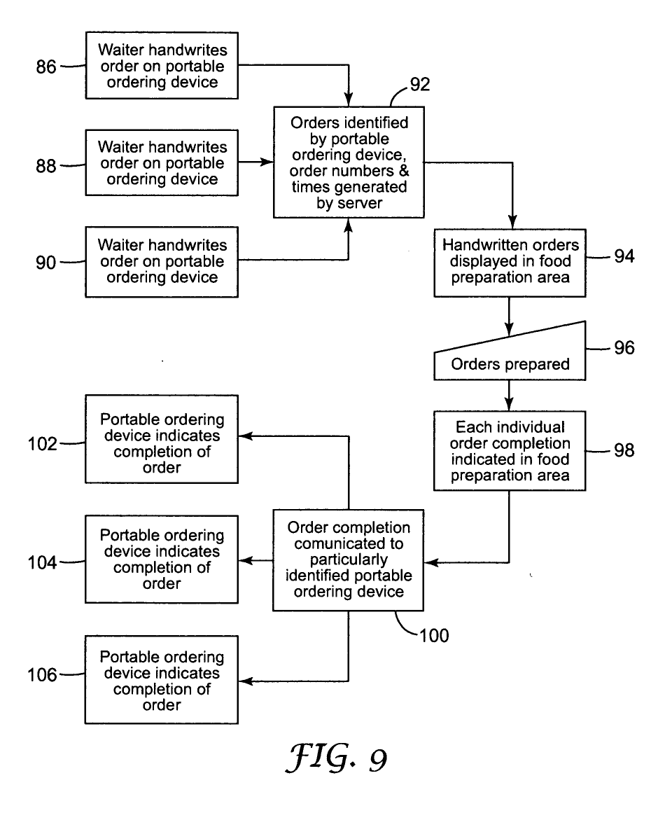

FIG. 9 is a flow chart illustration of another embodiment of the present invention with a plurality of portable ordering devices 14. Each wait staff person 62, each with their individual portable ordering device 14, individually creates handwritten indicia [blocks 86, 88 and 90] representative of individual orders. The orders are uniquely identified by the portable ordering device from which the orders originated and are assigned order numbers [block 92] by server 18. The time of each order may also be assigned or confirmed by server 18. The handwritten indicia from all of the orders are displayed [block 94] in food preparation area 22. The preparation staff prepare the order [block 96] (which is included for clarity but isn't actually a part of the communication process). In an embodiment, order completion is indicated [block 98] in the food preparation area 22. Order completion is communicated [block 100] to the particular portable ordering device 14 which placed the order. Thus, each portable ordering device 14 receives [blocks 102, 104 and 106] and displays an indication that an order placed from that unique portable ordering device has been completed. While order completion steps indicated in blocks 98, 100, 102, 104 and 106 are illustrated as separate steps to illustrate the geographic impact, it is to be recognized and understood that these steps can be considered single steps of communicating order completion to portable ordering devices 14.

It is to be recognized and understood that food orders may constitute orders representing items that are related to food such as beverages ordered in conjunction with food or beverages ordered separately or independently. It is to be recognized and understood that restaurants includes all kinds of establishments which serve food, including beverages as discussed above, to customers, such as, but not limited to, bars, all types of restaurants and other establishments which serve food and/or beverage items and in which orders are taken. It is to be recognized and understood that food preparation area includes any area in which food and/or beverage items are prepared, collected, selected or otherwise made available for delivery to the customer. While the invention has been described, for convenience, as being useful in a restaurant having tables at which customers are located, it is to be recognized and understood that the invention is not limited to such restaurants and is useful in restaurants in which customers may order food and/or beverages without the use of tables.

Various modifications and alterations of this invention will be apparent to those skilled in the art without departing from the scope and spirit of this invention. It should be understood that this invention is not limited to the illustrative embodiments set forth above.

1. A method of communicating a plurality of food orders in a restaurant from a plurality of portable ordering devices to a food preparation area, comprising the steps of:
creating handwritten indicia representative at least an aspect of one of said plurality of food orders on one of said plurality of ordering devices; and
wirelessly communicating said indicia from said one of said plurality of portable ordering devices for display in said food preparation area.

2. A method of communicating as in claim 1 wherein said wirelessly communicating step is accomplished in substantially real time.

3. A method of communicating as in claim 1 wherein said food preparation area is centralized.

4. A method of communicating a plurality of food orders in a restaurant from a portable ordering device to a food preparation area, comprising the steps of:
creating handwritten indicia representative of at least an aspect of at least an aspect of one of said plurality of food orders on portable ordering device; and
wirelessly communicating said indicia from said portable ordering device for display in said food preparation area.

5. A method of communicating as in claim 4 wherein said wirelessly communicating step is accomplished in substantially real time.

6. A method of communicating as in claim 4 wherein said food preparation area is centralized.

7. A method of communicating a plurality of food orders in a restaurant from a plurality of portable ordering devices to a centralized food preparation area, comprising the steps of:
indicating one of said plurality of food orders on one of said plurality of ordering devices;
wirelessly communicating said indication from said one of said plurality of portable ordering devices in substantially real time for display in said food preparation area, said indicia being uniquely identified with said one of said plurality of portable ordering devices;
wirelessly communicating completion of said one of said plurality of food orders to said one of said plurality of portable ordering devices.

8. A method of communicating as in claim 7 wherein said completion is indicated at said food preparation area.

9. A method of communicating as in claim 7 wherein said wirelessly communicating step is accomplished in substantially real time.

10. A method of communicating a plurality of food orders in a restaurant from a portable ordering device to a food preparation area, comprising the steps of:
indicating one of said plurality of food orders on said portable ordering device;
wirelessly communicating said indication from said portable ordering device for display in said food preparation area; and
wirelessly communicating completion of said one of the said plurality of food orders to said portable ordering device.

11. A method of communicating as in claim 10 wherein both wirelessly communicating steps are accomplished in substantially real time.

12. A method of communicating as in claim 10 wherein said food preparation area is centralized.

13. A method of communicating a plurality of food orders in a restaurant from a plurality of portable ordering devices to a food preparation area, comprising the steps of:
creating indicia representative of at least an aspect of one of said plurality of food orders on one of said plurality of portable ordering devices;
first wirelessly communicating said indicia from said one of said plurality of portable ordering devices to said food preparation area, said indicia being uniquely identified with said one of said plurality of portable ordering devices;
second wirelessly communicating completion of said one of said plurality of orders to said one of said plurality of portable ordering devices.

14. A method of communicating as in claim 13 wherein said wirelessly communicating step is accomplished in substantially real time.

15. A method of communicating as in claim 13 wherein said food preparation area is centralized.

16. A method of communicating as in claim 13 wherein said indicia comprises handwritten indicia.

17. A method of communicating as in claim 13 wherein first wirelessly communicating step comprises displaying said indicia.

18. A method of communicating a plurality of food orders in a restaurant from a portable ordering device to a food preparation area, comprising the steps of:
creating indicia representative of at least an aspect of one of said plurality of food orders on said portable ordering device;
first wirelessly communicating said indicia from said portable ordering device to said food preparation area;
second wirelessly communicating completion of said one of the said plurality of orders to said portable ordering device.

19. A method of communicating as in claim 18 wherein said wirelessly communicating step is accomplished in substantially real time.

20. A method of communicating as in claim 18 wherein said food preparation area is centralized.

21. A method of communicating as in claim 18 wherein said indicia comprises handwritten indicia.

22. A method of communicating as in claim 21 wherein first wirelessly communicating step comprises displaying said handwritten indicia.

23. A system for communicating a plurality of food orders in a restaurant, comprising:
a plurality of portable ordering devices, each of said plurality of portable ordering devices being capable of wireless communication and being capable of receiving handwritten indicia indicative of one of said plurality of food orders;
a communication processor wirelessly coupled with said plurality of portable ordering devices;
a display, operatively coupled to said communication processor, for displaying in a food preparation area; and
said communication processor wirelessly receiving said handwritten indicia uniquely identified with said one of said plurality of portable ordering devices and displaying said handwritten indicia on said display.

24. A system as in claim 23 wherein said wirelessly receiving is accomplished in substantially real time.

25. A system as in claim 23 wherein said food preparation area is centralized.

26. A system as in claim 23 wherein said communication processor further wirelessly indicates completion of said one of said plurality of food orders to said one of said plurality of ordering devices.

27. A system for communicating a plurality of food orders in a restaurant, comprising:
a portable ordering device being capable of wireless communication and being capable of receiving handwritten indicia indicative of one of said plurality of food orders;
a communication processor wirelessly coupled with said portable ordering device;
a display, operatively coupled to said communication processor, for displaying in said food preparation area; and
said communication processor wirelessly receiving said handwritten indicia and displaying said handwritten indicia on said display.

28. A system as in claim 27 wherein said wirelessly receiving is accomplished in substantially real time.

29. A system as in claim 27 wherein said food preparation area is centralized.

30. A system as in claim 27 wherein said communication processor further wirelessly indicates completion of said one of said plurality of food orders to said portable ordering device.

31. A system for communicating a plurality of food orders in a restaurant from a plurality of portable ordering devices to a food preparation area, comprising:
a plurality of portable ordering devices, each of said plurality of portable ordering devices being capable of wireless communication and being capable of receiving indicia indicative of one of said plurality of food orders;
a communication processor wirelessly coupled with said plurality of portable ordering devices;
a display, operatively coupled to said communication processor, for display in said food preparation area;
said communication processor wirelessly receiving said indicia uniquely identified with said one of said plurality of portable ordering devices and displaying said indicia on said display;
said communication processor wirelessly indicating completion of said one of said plurality of food orders to said one of said plurality of ordering devices.

32. A system as in claim 31 wherein said wirelessly receiving is accomplished in substantially real time.

33. A system as in claim 31 wherein said food preparation area is centralized.

34. A system as in claim 31 wherein said indicia comprises handwritten indicia.

35. A system for communicating a plurality of food orders in a restaurant, comprising:
a portable ordering device being capable of wireless communication and being capable of receiving indicia indicative of one of said plurality of food orders;
a communication processor wirelessly coupled with said plurality of portable ordering devices;
a display, operatively coupled to said communication processor, for display in a food preparation area;
said communication processor wirelessly receiving said indicia and displaying said indicia on said display;
said communication processor wirelessly indicating completion of said one of said plurality of food orders to said portable ordering device.

36. A system as in claim 35 wherein said wirelessly receiving is accomplished in substantially real time.

37. A system as in claim 35 wherein said food preparation area is centralized.

38. A system as in claim 35 wherein said indicia comprises handwritten indicia.
